(19) United States
(12) Patent Application Publication
(10) Pub. No.: US 2017/0074413 A1
(43) Pub. Date: Mar. 16, 2017

(54) Pressure Control Device with Blind Tapped Connection Base

(71) Applicant: Emerson Process Management Regulator Technologies Tulsa, LLC, Tulsa, OK (US)

(72) Inventor: John D. Cockerham, Tulsa, OK (US)

(73) Assignee: Emerson Process Management Regulator Technologies Tulsa, LLC, Tulsa, OK (US)

(21) Appl. No.: 15/261,131

(22) Filed: Sep. 9, 2016

Related U.S. Application Data
(60) Provisional application No. 62/219,455, filed on Sep. 16, 2015.

(51) Int. Cl. F16K 17/196; B65D 51/18

(52) U.S. Cl. CPC F16K 17/196; B65D 51/18

(57) ABSTRACT

A pressure control device is provided for use with a storage container. The pressure control device includes a base defined by a sidewall and a flange extending outwardly from the sidewall, the flange adapted to be connected to a surface of the storage container, the base including a port defined by the sidewall and adapted to be in fluid communication with an interior of the storage container. The pressure control device includes a lid movably coupled to the base to selectively expose the port of the base to an environment surrounding the pressure control device, and a plurality of blind holes formed in a bottom side of the flange of the base. The plurality of blind holes are configured to facilitate connection of the pressure control device to the storage container while preventing leakage from the storage container through the connection, thereby reducing fugitive emissions.

### FIELD OF THE DISCLOSURE

The present disclosure is directed to pressure control devices for storage containers and, more particularly, to a pressure control device with a blind tapped connection base that, when coupled to a storage container, reduces the likelihood of fugitive emissions from that storage container.

### BACKGROUND

Storage containers, such as storage tanks, vessels, conduits, and the like, can be utilized to store various fluids (e.g., oil, gas, etc.). The internal vapor pressure of these storage containers may vary based on various factors, such as, for example, the amount of fluid in the storage container, the temperature of the fluid in the storage container, the volatility of the fluid in the storage tank, the temperature outside the storage container, and the rate of filling or emptying. Pressures above or below certain thresholds may, however, damage the storage container. For example, positive pressures or vacuum over-pressures may cause the storage container to collapse. Pressures above certain thresholds can also lead to excess emissions and product loss, while pressures below certain thresholds can compromise the quality of the fluid stored in the container (as this increases the likelihood that contaminants will be pulled in from the atmosphere).

Pressure control devices, e.g., thief hatches, lock down hatches, pressure vacuum relief valves, and emergency pressure relief valves, can be installed on a storage container to control pressure in the storage container, e.g., relieve undesirably high or undesirably low pressures in the storage container that can occur as a result of any of the above-noted factors. Conventionally, pressure control devices such as thief hatches and lock down hatches are directly attached to the roof of the storage container with fasteners (e.g., studs, bolts, nuts, and the like) by way of holes cut directly into the roof of the storage container and associated through holes formed in the connection flange of the pressure control device. However, attaching pressure control devices in this way tends to create a source of fugitive emissions, i.e., emissions of gases or vapors from pressurized equipment due to leaks or other unintended releases of gases or vapors, as gases or vapors can escape from the storage container to the ambient environment through the holes. This is particularly problematic in oil and gas applications, which tend to generate volatile organic compounds (VOCs) and other dangerous emissions. As a result, oil and gas applications have been the subject of increasing regulatory focus in recent years.

### SUMMARY

In accordance with a first exemplary aspect of the present invention, a pressure control device is provided for use with a storage container. The pressure control device includes a base defined by a sidewall and a flange extending outwardly from the sidewall. The flange is adapted to be connected to a surface of the storage container. The base includes a port defined by the sidewall and adapted to be in fluid communication with an interior of the storage container. The pressure control device also includes a lid movably coupled to the base to selectively expose the port of the base to an environment surrounding the pressure control device. The pressure control device further includes a plurality of blind holes formed in a bottom side of the flange of the base. The plurality of blind holes are configured to facilitate connection of the pressure control device to the storage container while preventing leakage from the storage container through the connection, thereby reducing fugitive emissions.

In accordance with a second exemplary aspect of the present invention, a pressure control device is provided for use with a storage container. The pressure control device includes a base defined by a sidewall and a flange extending outwardly from the sidewall. The flange is adapted to be connected to a surface of the storage container. The base includes a port defined by the sidewall and adapted to be in fluid communication with an interior of the storage container. The pressure control device also includes a lid movably coupled to the base to selectively expose the port of the base to an environment surrounding the pressure control device. The pressure control device further includes a plurality of holes formed in the flange of the base. The plurality of holes extend only partially between a top side and a bottom side of the flange of the base. The plurality of holes facilitate connection of the pressure control device to the storage container while preventing leakage from the storage container through the connection, thereby reducing fugitive emissions.

In accordance with a third exemplary aspect of the present invention, In accordance with a first exemplary aspect of the present invention, a pressure control device is provided for use with a storage container. The pressure control device includes a base defined by a sidewall and a flange extending outwardly from the sidewall. The flange is adapted to be connected to a surface of the storage container. The base includes a port defined by the sidewall and adapted to be in fluid communication with an interior of the storage container. The pressure control device also includes a lid movably coupled to the base to selectively expose the port of the base to an environment surrounding the pressure control device. The pressure control device further includes a plurality of blind holes formed in a bottom side of the flange of the base. The plurality of blind holes are configured to facilitate connection of the pressure control device to the storage container while preventing leakage from the storage container through the connection, thereby reducing fugitive emissions. The pressure control device further includes a plurality of fasteners sized to be arranged in the plurality of blind holes, respectively, to facilitate the connection of the pressure control device to the storage container.

In further accordance with any one or more of the foregoing first, second, and third exemplary aspects, a pressure control device may include any one or more of the following further preferred forms.

In one preferred form, the plurality of blind holes are circumferentially arranged around the central passage of the base.

In another preferred form, the flange has a first depth, and wherein each of the plurality of blind holes has a second depth equal to 25% to 75% of the first depth.

In another preferred form, the pressure control device further includes a plurality of fasteners arranged in the plurality of blind holes for connecting the pressure control device to the storage container.

In another preferred form, each of the plurality of fasteners has a diameter and each of the plurality of blind holes has a depth that is between 2 and 3 times the diameter of a respective fastener of the plurality of fasteners.

In another preferred form, the lid includes a circumferential edge and a sealing element arranged in a channel formed in the circumferential edge. The lid is movable between a closed position, in which the sealing element sealingly engages a top end of the sidewall, thereby sealing the port of the base from the environment, and an open position, in which the sealing element is spaced from the top end of the sidewall, thereby exposing the port to the environment.

In another preferred form, the pressure control device further includes a pressure relief assembly for providing pressure relief to the storage container. The pressure relief assembly includes a center assembly coupled to the lid, and a pressure sealing element coupled to the center assembly. The center assembly is movable between a non-operational position, in which the pressure sealing element engages a top end of the base, thereby preventing fluid communication between the port and the environment, and a pressure relief position, in which the pressure sealing element is spaced from the top end of the base, thereby facilitating fluid communication between the port and the environment.

In another preferred form, a pressure spring is arranged within a space defined by the lid and the center assembly. The pressure spring is configured to bias the center assembly to the non-operational position.

In another preferred form, the pressure control device further includes a vacuum relief assembly for providing vacuum relief to the storage container. The vacuum relief assembly includes a vacuum pallet, and a vacuum sealing element coupled to the vacuum pallet. The vacuum pallet is movable between a non-operational position, in which the vacuum sealing element engages a portion of the pressure control device, thereby preventing fluid communication between the port and the environment, and a vacuum relief position, in which the vacuum sealing element is spaced from the portion of the pressure control device, thereby facilitating fluid communication between the port and the environment.

In another preferred form, the plurality of fasteners are integrally formed into the plurality of blind holes, respectively.

### BRIEF DESCRIPTION OF THE DRAWINGS

The features of this invention which are believed to be novel are set forth with particularity in the appended claims. The invention may be best understood by reference to the following description taken in conjunction with the accompanying drawings, in which like reference numerals identify like elements in the several FIGS., in which:

FIG. 1 is a schematic of a pressure control device coupled to a storage container;

FIG. 2 is a perspective view of one example of the pressure control device of FIG. 1 constructed in accordance with the teachings of the present invention;

FIG. 3 is a cross-sectional view of the pressure control device of FIG. 2, taken along line 3-3 in FIG. 2;

FIG. 4 is a perspective view of another example of the pressure control device of FIG. 1 constructed in accordance with the teachings of the present invention;

FIG. 5 is a cross-sectional view of the pressure control device of FIG. 4, taken along line 5-5 in FIG. 4;

FIG. 6 is a perspective view of yet another example of the pressure control device of FIG. 1 constructed in accordance with the teachings of the present invention; and

FIG. 7 is a cross-sectional view of the pressure control device of FIG. 6, taken along line 7-7 in FIG. 6.

### DETAILED DESCRIPTION

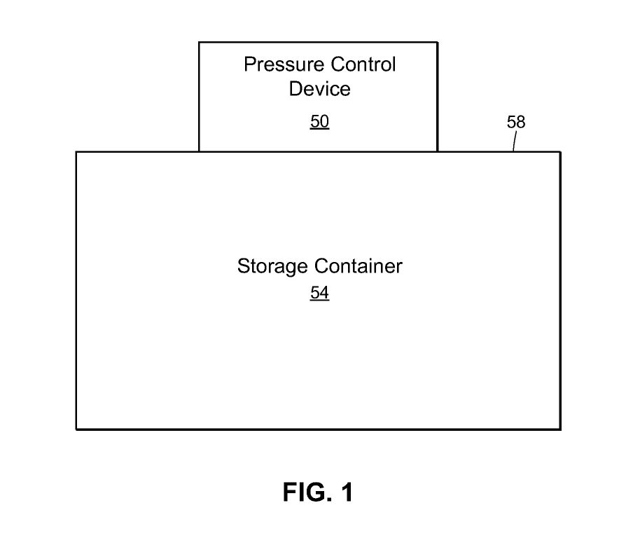

FIG. 1 generally illustrates a pressure control device 50 coupled to (e.g., installed on, mounted to) a storage container 54 to control the pressure within the storage container 54. The storage container 54 can be a storage tank, a storage vessel, a storage conduit, or other container used to store oil, gas, water, or products. The storage container 54 generally includes a plurality of through holes formed (e.g., cut) directly into a surface 58 (e.g., the roof) of the storage container 54, with the pressure control device 50 coupled to the surface 58 of the storage container 54 via these through holes. In turn, the pressure control device 50 can help to control the pressure within the storage container 54, which, as noted above, can vary for any number of reasons.

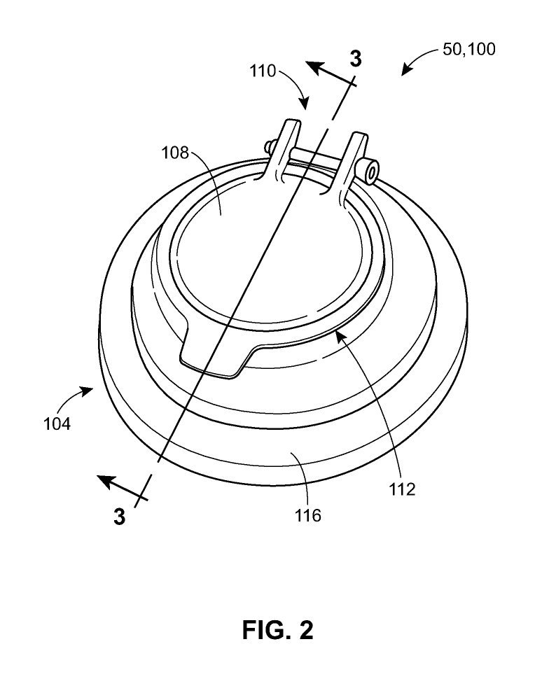

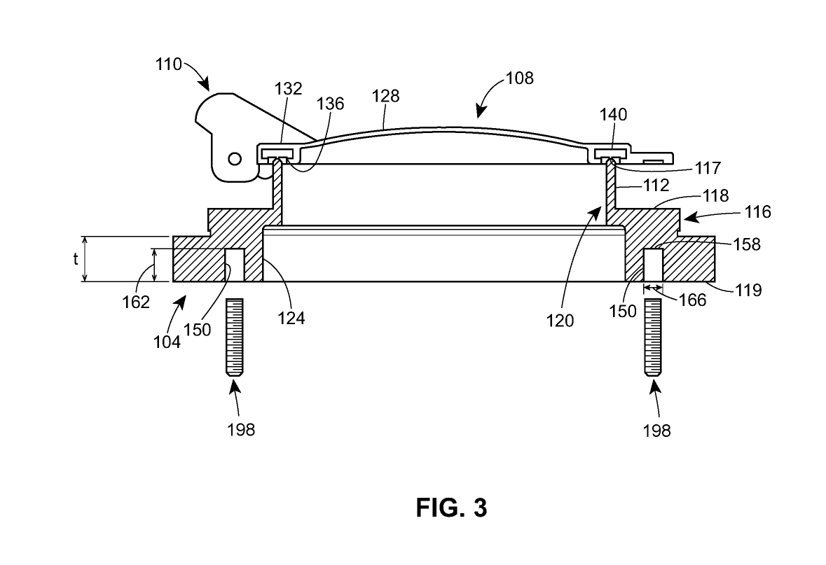

FIGS. 2 and 3 illustrate one example of the pressure control device 50, in the form of a thief hatch 100, that can be coupled to (e.g., installed on) the storage container 54. The thief hatch 100 illustrated in FIGS. 2 and 3 is manufactured by Emerson Process Management. As illustrated in FIGS. 2 and 3, the thief hatch 100 includes a base 104 and a lid or cover 108 movably coupled to the base 104 via a hinged structure 110. The base 104 is generally configured to be coupled (e.g., mounted, attached) to the surface 58 of the storage container 54 in a “leak-proof” manner, while the lid or cover 108 is generally movable relative to the base 104 to control fluid flow from the storage container 54, through the base 104, and out of the base 104, such that the thief hatch 100 can control the pressure within the storage container 54. When, for example, the pressure within the storage container 54 exceeds a threshold pressure (e.g., a venting threshold pressure), the lid or cover 108 is configured to move to an open position (not shown), thereby permitting fluid communication between an interior of the storage container 54 and the environment surrounding the thief hatch 100 and the storage container 54. In turn, fluid (e.g., vapor) can be vented from the interior of the storage container 54, thereby decreasing the pressure within the storage container 54. Once the pressure within the storage container 54 falls below the threshold pressure, the lid or cover 108 is configured to automatically close and re-seal the body 104, thereby blocking or sealing off fluid communication between the interior of the storage container 54 and the environment surrounding the thief hatch 100 and the storage container 54.

With reference still to FIGS. 2 and 3, the base 104 of the thief hatch 100 is defined by a sidewall 112 and a flange 116 formed integrally with the sidewall 112. The base 104 in this example has a thickness that is greater than a thickness of a base of a conventional thief hatch. The sidewall 112 in this example is a circumferential sidewall (i.e., it has an annular shape) with an open top end 117 and a bottom end 120. The flange 116 extends outwardly and downwardly from the bottom end 120 of the sidewall 112. The flange 116 has a first, or top, side 118 and a second, or bottom, side 119 for mating with the storage container 54 in a “leak proof” manner, as will be described in greater detail below. While not illustrated herein, it will be appreciated that a sealing element (e.g., a gasket) can be disposed or arranged on the bottom side 119 of the flange 116.

As best shown in FIG. 3, the body 104 defines a port or passage 124 defined by the sidewall 112 and the flange 116. The port 124 is arranged to be in fluid communication with the interior of the storage container 54 (e.g., via an access opening formed in the storage container 54) when the flange 116 is mated with the storage container 54 such that the thief hatch 100 is coupled to the storage container 54. The port 124 is also arranged to be in fluid communication with the atmosphere when the lid or cover 108 is in the open position, such that the port 124 can fluidly couple the interior of the storage container 54 with the atmosphere.

The lid or cover 108 in the illustrated example has a substantially annular body 128 with a circumferential edge 132. The lid or cover 108 includes a sealing element 136, which in this example takes the form of an annular gasket, disposed or arranged in a channel 140 defined in the circumferential edge 132. When the lid or cover 108 is in the closed position, which is illustrated in FIG. 2, the circumferential edge 132, along with the sealing element 136, sealingly engage the top end 117 of the sidewall 112 of the base 104, thereby sealing or closing the port 124 from the environment. However, when the lid or cover 108 is moved to the open position (not shown), the circumferential edge 132, along with the sealing element 136, are spaced from the top end 117 of the sidewall 112, thereby exposing the port 124 to the environment and, in turn, fluidly connecting the interior of the storage container to the atmosphere.

Unlike conventional thief hatches, which utilize through holes to facilitate the connection to the storage container, the thief hatch 100 includes a plurality of blind holes 150 formed (e.g., tapped) in the bottom side 119 of the flange 116 of the base 104. In other words, the holes 150 extend only partially through the flange 116, with each hole 150 extending between the bottom side 119 and an interior portion 158 of the flange 116. The thief hatch 100 in this example includes sixteen (16) blind holes 150 circumferentially arranged around the port 124, though any number of blind holes 150 can be utilized and/or the blind holes 150 can be arranged in a different manner (e.g., spaced at different distances from one another). The depth 162 of each of the holes 150 can vary according to, for example, the size of the storage container 54, the thickness t of the flange 116, and/or the diameter of a fastener to be formed or inserted therein for coupling the thief hatch 100 to the storage container 54. As an example, the depth 162 of each of the holes 150 can be in a range of between two (2) and three (3) times the size of the diameter of the fastener to be formed or inserted therein. It will be also appreciated that the blind holes 150 need not have the same depths 162, i.e., one or more of the blind holes 150 can have a different depth 162 than one or more other blind holes 150. The diameter 166 of each of the holes 150 can also vary according to, for example, the size of the storage container, the thickness t of the flange 116, and/or the diameter of the fastener to be formed or inserted therein. As with the depths 162, it will be appreciated that the blind holes 150 need not have the same diameters 166, i.e., one or more of the blind holes 150 can have a different diameter 166 than one or more other blind holes 150.

A plurality of fasteners 198 can be used to couple (e.g., mount, attach) the thief hatch 100 to the storage container 54. More specifically, the plurality of fasteners 198 can be used to connect the base 104 of the thief hatch 100 to the surface 58 (e.g., the roof) of the storage container 54. The fasteners 198 can take the form of studs, bolts, nuts, and/or the like. In some cases, the plurality of fasteners 198 can be integrally disposed or formed into the plurality of blind holes 150, while in other cases, the plurality of fasteners 198 can be separately manufactured and then disposed or inserted into the plurality of blind holes 150 by a user (e.g., an end user at the facility in which the storage container 54 resides) or a machine. In any event, the plurality of fasteners 198, once inserted into the blind holes 150, will extend outwardly (downwardly in FIG. 2) from the bottom side 154 of the flange 116, and can be subsequently inserted or disposed in the through holes formed in the surface 58 of the storage container 54 to couple the thief hatch 100 to the storage container 54. Such an arrangement allows the thief hatch 100 to be coupled to the storage container 54 in an easy and quick manner. Moreover, in cases in which the plurality of fasteners 198 are integrally disposed into the plurality of blind holes 150 or are separately manufactured but inserted into the plurality of blind holes 150 before the thief hatch 100 reaches the facility, the thief hatch 100 can be coupled to the storage container 54 in an even quicker and easier manner (by simply inserting the fasteners 198 into the through holes formed in the surface 58 of the storage container 54).

As discussed above, the connection between conventional pressure control devices and a storage container tends to create a source of fugitive emissions, with gases or vapors escaping from the storage container to the ambient environment through the through holes. However, the thief hatch 100, by utilizing the blind holes 150 instead of through holes to connect to the storage container 54, eliminates this source of fugitive emissions, as gases or vapors no longer have a leakage path from the storage container 54 to the ambient environment via the connection, thereby reducing the potential for fugitive emissions.

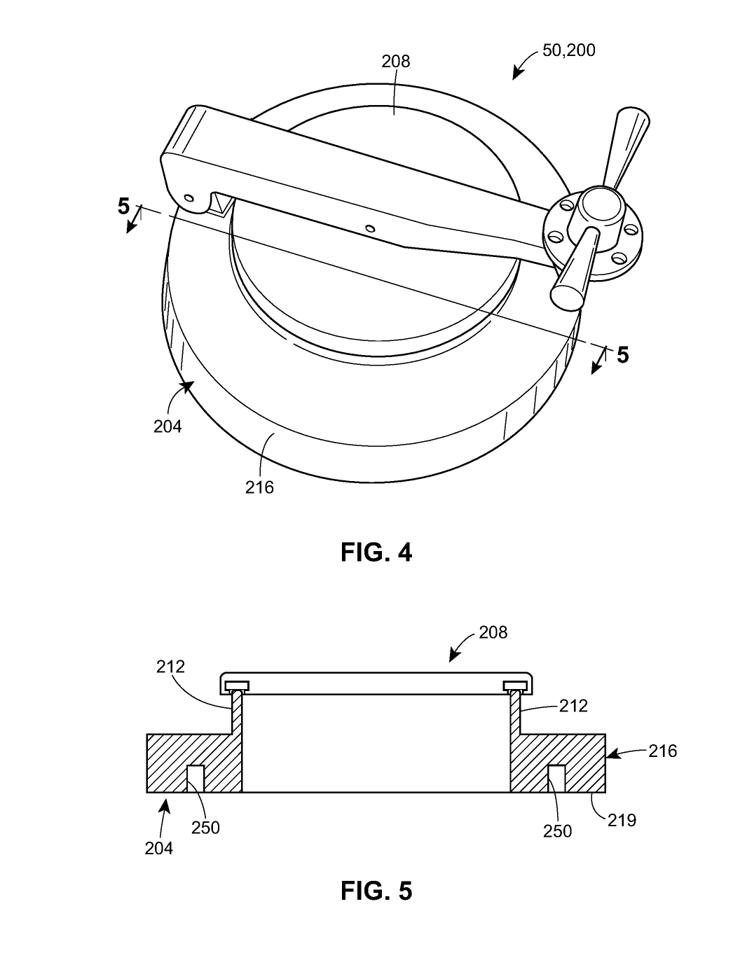

FIGS. 4 and 5 illustrate another example of the pressure control device 50, in the form of a lock down hatch 200, that can be coupled to (e.g., installed on) the storage container 54. The lock down hatch 200 is similar to the thief hatch 100 described above, with similar reference numerals used for similar components, but has a slightly different base 204 and lid or cover 208. It will be appreciated that the lock down hatch 200, when coupled to the storage container 54, operates in a slightly different manner than the thief hatch 100. Like the lid or cover 108, the lid or cover 208 is movable relative to the base 204, however the lid or cover 208 generally remains in the closed position and is typically only moved to the open position by a user or a machine to provide access to the interior of the storage container 54 (e.g., for temperature measurement). In any event, the lock down hatch 200 can be coupled to the storage container 54 in a similar manner as the thief hatch 100. In other words, the lock down hatch 200 includes a plurality of blind holes 250, similar to the blind holes 150, that can be used to couple the base 204 of the lock down hatch 200 to the surface 58 of the storage container 54. As such, the lock down hatch 200, like the thief hatch 100, eliminates this source of fugitive emissions, as gases or vapors no longer have a leakage path from the storage container 54 to the ambient environment via the connection, thereby reducing the potential for fugitive emissions.

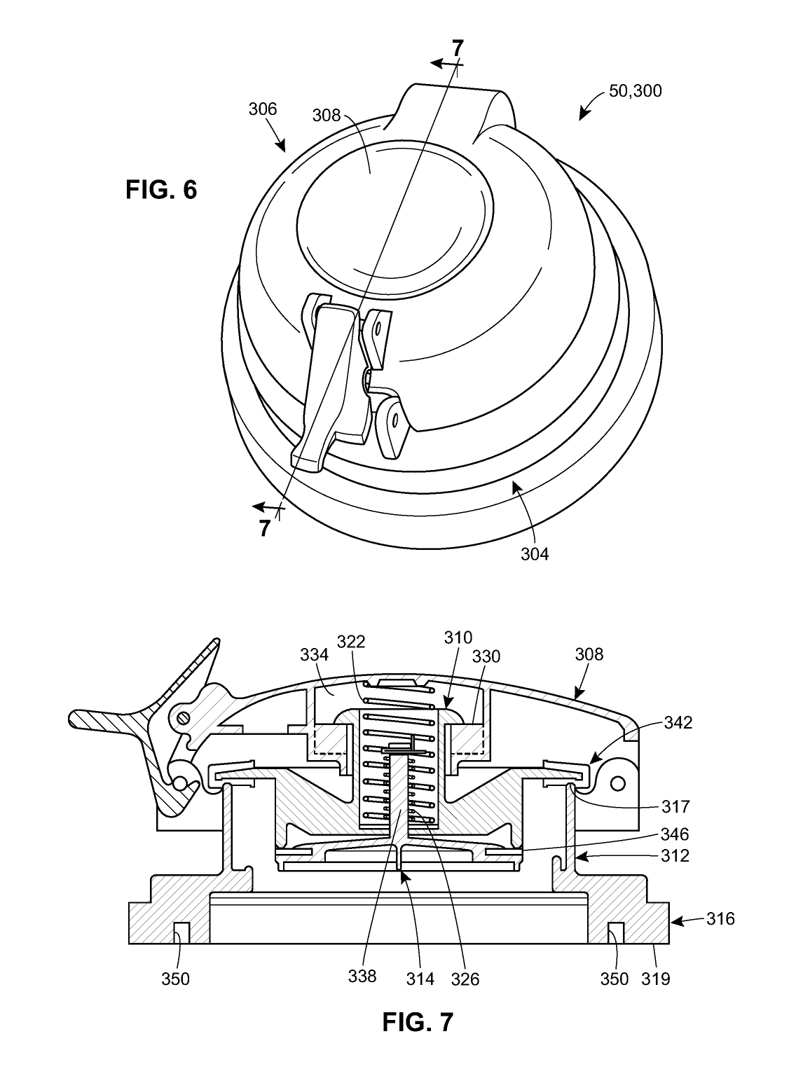

FIGS. 6 and 7 illustrate yet another example of the pressure control device 50, in the form of a thief hatch 300, that can be coupled to (e.g., installed on) the storage container 54. The thief hatch 300 is similar to the thief hatch 100 described above, with similar reference numerals used for similar components, but has a slightly different base 304 and a lid assembly 306 coupled thereto. It will be appreciated that the thief hatch 300, when coupled to the storage container 54, operates in a slightly different manner than the thief hatch 100, as the thief hatch 300 is configured to provide the storage container 54 (when coupled thereto) with both vacuum and pressure relief.

To this end, the lid assembly 306 includes a lid or cover 308, a center assembly 310, a vacuum pallet assembly 314, a pressure spring 322, and a vacuum spring 326, as illustrated in FIG. 7. The center assembly 310 is coupled to the lid or cover 308 via a downwardly and inwardly extending portion 330 of the lid or cover 308. The pressure spring 322 is arranged within a space 334 defined by the lid or cover 308 and the center assembly 310, with the pressure spring 322 surrounding an upwardly extending stem 338 of the vacuum pallet assembly 314. The vacuum spring 326 is also arranged within the space 334, but is nested inside of the pressure spring 314. Accordingly, the vacuum spring 326 also surrounds the upwardly extending stem 338 of the vacuum pallet assembly 314. The lid assembly 306 also includes a pressure sealing element (e.g., a gasket) 342 and a vacuum sealing element (e.g., a gasket) 346. The pressure sealing element 342 is arranged on an outwardly extending portion of the center assembly 310, while the vacuum sealing element 346 is arranged on an outwardly extending portion of the vacuum pallet assembly 314, as illustrated in FIG. 7.

The center assembly 310 is generally movable in a vertical direction based on a set pressure achieved by the pressure spring 322. The movement of the center assembly 310 is, however, limited or guided by the lid or cover 308. When the thief hatch 300 is in its initial or non-operational position (i.e., it is not providing vacuum or pressure relief), the pressure sealing element 342 sealingly engages the open top end 317 of the sidewall 312 of the base 304, and the vacuum sealing element 346 sealingly engages a bottom portion of the center assembly 310. When, however, the pressure within the storage container 54 exceeds a maximum pressure threshold (i.e., pressure relief is needed), such that the pressure from the storage container 54 acting on the center assembly 310 exceeds the counteracting force provided by the pressure spring 322, the center assembly 310 moves vertically upward. This movement decouples the pressure sealing element 342 from the sidewall 312 of the base 304, thereby providing pressure relief to the storage container 54. When, however, the pressure from the storage container 54 falls below a minimum or vacuum pressure threshold (i.e., vacuum relief is needed), such that the vacuum from the storage container 54 exceeds the counteracting force provided by the vacuum spring 326, the vacuum pallet assembly 314 moves vertically downward. This movement decouples the vacuum sealing element 346 from the center assembly 310 (which cannot move in a downward direction due to the lid or cover 308), thereby providing vacuum relief to the storage container 54.

Notwithstanding the operational differences between the thief hatch 300 and the hatches 100, 200, the thief hatch 300 can be coupled to the storage container 54 in a similar manner as the thief hatch 100 and the lock down hatch 200. In other words, the thief hatch 300 includes a plurality of blind holes 350, similar to the blind holes 150, that can be used to couple the base 304 of the thief hatch 300 to the surface 58 of the storage container 54. As such, the thief hatch 300, like the thief hatch 100 and the lock down hatch 200, eliminates fugitive emissions that may otherwise result as a result of the connection between the thief hatch 300 and the storage container 54, thereby reducing potential for fugitive emissions.

Finally, while pressure control devices 50 in the form of the thief hatch 100, the lock down hatch 200, and the thief hatch 300 have been illustrated herein, the pressure control device 50 can, in other examples, take the form of a different type of thief hatch or lock down hatch, a PVRV, or another type of pressure control device. Additionally, while not illustrated herein, it is conceivable that the principles described herein—blind hole tapping to facilitate a leak proof connection, can be incorporated into an adapter for coupling a pressure control device to the storage container 54.

1. A pressure control device for use with a storage container, the pressure control device comprising:
a base defined by a sidewall and a flange extending outwardly from the sidewall, the flange adapted to be connected to a surface of the storage container, the base comprising a port defined by the sidewall and adapted to be in fluid communication with an interior of the storage container;
a lid movably coupled to the base to selectively expose the port of the base to an environment surrounding the pressure control device; and
a plurality of blind holes formed in a bottom side of the flange of the base, the plurality of blind holes configured to facilitate connection of the pressure control device to the storage container while preventing leakage from the storage container through the connection, thereby reducing fugitive emissions.

2. The pressure control device of claim 1, wherein the plurality of blind holes are circumferentially arranged around the central passage of the base.

3. The pressure control device of claim 1, wherein the flange has a first depth, and wherein each of the plurality of blind holes has a second depth equal to 25% to 75% of the first depth.

4. The pressure control device of claim 1, further comprising a plurality of fasteners arranged in the plurality of blind holes for connecting the pressure control device to the storage container.

5. The pressure control device of claim 4, wherein each of the plurality of fasteners has a diameter and each of the plurality of blind holes has a depth that is between 2 and 3 times the diameter of a respective fastener of the plurality of fasteners.

6. The pressure control device of claim 1, wherein the lid comprises a circumferential edge and a sealing element arranged in a channel formed in the circumferential edge, and wherein the lid is movable between a closed position, in which the sealing element sealingly engages a top end of the sidewall, thereby sealing the port of the base from the environment, and an open position, in which the sealing element is spaced from the top end of the sidewall, thereby exposing the port to the environment.

7. The pressure control device of claim 1, further comprising a pressure relief assembly for providing pressure relief to the storage container, the pressure relief assembly comprising:
a center assembly coupled to the lid; and
a pressure sealing element coupled to the center assembly, wherein the center assembly is movable between a non-operational position, in which the pressure sealing element engages a top end of the base, thereby preventing fluid communication between the port and the environment, and a pressure relief position, in which the pressure sealing element is spaced from the top end of the base, thereby facilitating fluid communication between the port and the environment.

8. The pressure control device of claim 7, further comprising a pressure spring arranged within a space defined by the lid and the center assembly, the pressure spring configured to bias the center assembly to the non-operational position.

9. The pressure control device of claim 1, further comprising a vacuum relief assembly for providing vacuum relief to the storage container, the vacuum relief assembly comprising:
a vacuum pallet; and
a vacuum sealing element coupled to the vacuum pallet, wherein the vacuum pallet is movable between a non-operational position, in which the vacuum sealing element engages a portion of the pressure control device, thereby preventing fluid communication between the port and the environment, and a vacuum relief position, in which the vacuum sealing element is spaced from the portion of the pressure control device, thereby facilitating fluid communication between the port and the environment.

10. A pressure control device for use with a storage container, the pressure control device comprising:
a base defined by a sidewall and a flange extending outwardly from the sidewall, the flange adapted to be connected to a surface of the storage container, the base comprising a port defined by the sidewall and adapted to be in fluid communication with an interior of the storage container;
a lid movably coupled to the base to selectively expose the port of the base to an environment surrounding the pressure control device; and
a plurality of holes formed in the flange of the base, the plurality of holes extending only partially between a top side and a bottom side of the flange of the base, the plurality of holes configured to facilitate connection of the pressure control device to the storage container while preventing leakage from the storage container through the connection, thereby reducing fugitive emissions.

11. The pressure control device of claim 10, wherein the plurality of holes are circumferentially arranged around the central passage of the base.

12. The pressure control device of claim 10, wherein the flange has a first depth, and wherein each of the plurality of blind holes has a second depth equal to 25% to 75% of the first depth

13. The pressure control device of claim 10, further comprising a plurality of fasteners arranged in the plurality of holes for connecting the pressure control device to the storage container.

14. The pressure control device of claim 13, wherein each of the plurality of fasteners has a diameter and each of the plurality of holes has a depth that is between 2 and 3 times the diameter of a respective fastener of the plurality of fasteners.

15. The pressure control device of claim 10, wherein the lid comprises a circumferential edge and a sealing element arranged in a channel formed in the circumferential edge, and wherein the lid is movable between a closed position, in which the sealing element sealingly engages a top end of the sidewall, thereby sealing the port of the base from the environment, and an open position, in which the sealing element is spaced from the top end of the sidewall, thereby exposing the port to the environment.

16. The pressure control device of claim 10, further comprising a pressure relief assembly for providing pressure relief to the storage container, the pressure relief assembly comprising:
a center assembly coupled to the lid; and
a pressure sealing element coupled to the center assembly, wherein the center assembly is movable between a non-operational position, in which the pressure sealing element engages a top end of the base, thereby preventing fluid communication between the port and the environment, and a pressure relief position, in which the pressure sealing element is spaced from the top end of the base, thereby facilitating fluid communication between the port and the environment.

17. The pressure control device of claim 16, further comprising a pressure spring arranged within a space defined by the lid and the center assembly, the pressure spring configured to bias the center assembly to the non-operational position.

18. The pressure control device of claim 10, further comprising a vacuum relief assembly for providing vacuum relief to the storage container, the vacuum relief assembly comprising:
a vacuum pallet; and
a vacuum sealing element coupled to the vacuum pallet, wherein the vacuum pallet is movable between a non-operational position, in which the vacuum sealing element engages a portion of the pressure control device, thereby preventing fluid communication between the port and the environment, and a vacuum relief position, in which the vacuum sealing element is spaced from the portion of the pressure control device, thereby facilitating fluid communication between the port and the environment.

19. A pressure control device for use with a storage container, the pressure control device comprising:
a base defined by a sidewall and a flange extending outwardly from the sidewall, the flange adapted to be connected to a surface of the storage container, the base comprising a port defined by the sidewall and adapted to be in fluid communication with an interior of the storage container;
a lid movably coupled to the base to selectively expose the port of the base to an environment surrounding the pressure control device;
a plurality of blind holes formed in a bottom side of the flange of the base, the plurality of blind holes configured to facilitate connection of the pressure control device to the storage container while preventing leakage from the storage container through the connection, thereby reducing fugitive emissions; and
a plurality of fasteners sized to be arranged in the plurality of blind holes, respectively, to facilitate the connection of the pressure control device to the storage container.

20. The pressure control device of claim 19, wherein the plurality of fasteners are integrally formed into the plurality of blind holes, respectively.
